(19) United States
(12) Patent Application Publication
(10) Pub. No.: US 2015/0264493 A1
(43) Pub. Date: Sep. 17, 2015

(54) HEARING AID

(71) Applicant: Joowon Jung, Seongnam-si (KR)

(72) Inventor: Joowon Jung, Seongnam-si (KR)

(21) Appl. No.: 14/421,268

(22) PCT Filed: Aug. 8, 2014
(86) PCT No.: PCT/KR2014/007378

§ 371 Date: Feb. 12, 2015

(30) Foreign Application Priority Data
Oct. 24, 2013 (KR) 10-2013-0126933

(51) Int. Cl. H04R 25/00

(52) U.S. Cl. CPC H04R 25/552; H04R 25/556; H04R 25/65

(57) ABSTRACT

A hearing aid includes a sound collecting plate collecting sounds for transmitting sender's voice to a receiver, a first connecting tube connected to the sound collecting plate for transmitting the sound collected in the sound collecting plate, an earpiece for a receiver connected to the first connecting tube for listening to the sound collected in the sound collecting plate, and a necklace unit for a sender surrounding the sender's neck for the sender to transmit his voice through the sound collecting plate.

### TECHNICAL FIELD

Example embodiments of inventive concepts relate to a hearing aid, and more particularly, to a hearing aid transmitting sound of the other party to people who have impaired hearing ability effectively.

### BACKGROUND ART

A hearing aid is a device which is designed to correct impaired hearing and has been manufactured and used in various kinds of form.

The hearing aid includes a microphone for converting a voice signal into an electronic signal, an amplifier for amplifying electric signals output from the microphone, and a receiver converting the electronic signal output from the microphone to a voice signal and outputting the same.

Recently, the hearing aid may be minimized as an inner ear inserting type thanks to the development of manufacturing technology, which may not be revealed to the outside and is easy to wear, accordingly, preferred by most hearing aid users.

The prior arts of an inner ear inserting type hearing aid are Korean Patent Publication No. 10-2009-0088712, Korean Patent Publication No. 10-2004-0016345, and Korean Patent Registration No. 10-1063521.

The prior art, Korean Patent Publication No. 10-2009-0088712, includes an ear tip designed to be inserted inside a user's ear on the outer side of a shell installing a component for a hearing aid, and ring type wings formed into a columnar direction of the outer side of the ear tip, and the Korean Patent Publication No. 10-2004-0016345 and Korean Patent Registration No. 10-1063521 include a semi-sphere ear tip and an ear ring around the edge portion of a shell and a semi-sphere head unit closely inserted inside the ear, respectively.

However, the prior arts include wings formed on the peripheral side of the ear tip prepared as separate members while maintaining a certain distance with each other, or, the semi-sphere ear tip, the earring and the head unit block the inside of the ear from the outside completely such that air may not circulate inside the ear, thus feeling of wearing may be bad.

In that case, each wing may generate frictional power to a wearing part at a right direction when wearing or removing the hearing aid, because wings are made of separate members while keeping apart with each other, accordingly, wearing or removing the hearing aid may be inconvenient. With this reason, the lifespan of the ear tip may be shortened.

And Korean Patent Publication No. 10-2004-0016345 and Korean Patent Registration No. 10-1063521 include an ear tip of semi-spear and an earring around the edge portion of the shell, thus, problems like the above may be generated.

### DETAILED DESCRIPTION OF THE INVENTION

### Technical Goal of the Invention

According to an exemplary embodiment, the inventive concept provides a hearing aid including an earpiece for a receiver, a sound collecting plate, and a necklace unit for a sender.

### Technical Solution of the Invention

According to an exemplary embodiment of the inventive concept, a hearing aid may include a sound collecting plate collecting sounds from a sender and transmitting the same to a receiver, a first connecting tube connected to the sound collecting plate for transmitting the sound collected in the sound collecting plate, an ear piece connected to the first connecting tube for listening to the sound collected in the sound collecting plate, and a necklace unit for a sender surrounding his neck to transmit the sender's voice through a sound collecting plate.

The hearing aid may further include a binaural between the earpiece and the first connecting tube.

The earpiece for a sender and the binaural may be formed on each side of the first connecting tube dividing in the form of Y.

The hearing aid may further include a connecting bridge connecting the first connecting tube.

The hearing aid may further include a supporter connected to the necklace unit for a sender to support the necklace.

The hearing aid may further include a second connecting tube wrapping the first connecting tube and the supporter.

The hearing aid may further include a joining member for joining the first connecting tube and the supporter and fixing the same.

### EFFECT OF THE INVENTION

According to the inventive concept, a hearing aid may make conversation between a person who has impaired auditory ability and the other person more easily.

### BRIEF DESCRIPTION OF THE DRAWINGS

FIG. 1 is a perspective view of a hearing aid according to an exemplary embodiment of the inventive concept;

FIG. 2 is a diagram illustrating structure of a first connecting tube and a supporter; and

FIG. 3 is a diagram illustrating another structure of a first connecting tube and a supporter.

### BEST MODE FOR CARRYING OUT THE INVENTION

Various example embodiments will be described more fully hereinafter with reference to the accompanying drawings, in which some example embodiments are shown. Inventive concepts may, however, be embodied in many different forms and should not be construed as limited to the example embodiments set forth herein.

In the drawings, the sizes and relative sizes of layers and areas may be exaggerated for clarity, and the sizes are just examples not restrictions. Like numerals refer to like elements throughout.

The example embodiments of the present invention explain idealized example embodiments of the inventive concept in detail. Therefore, various convertations of diagrams may be performed. The example embodiments are not restricted to the diagrams and include convertation of form during manufacturing.

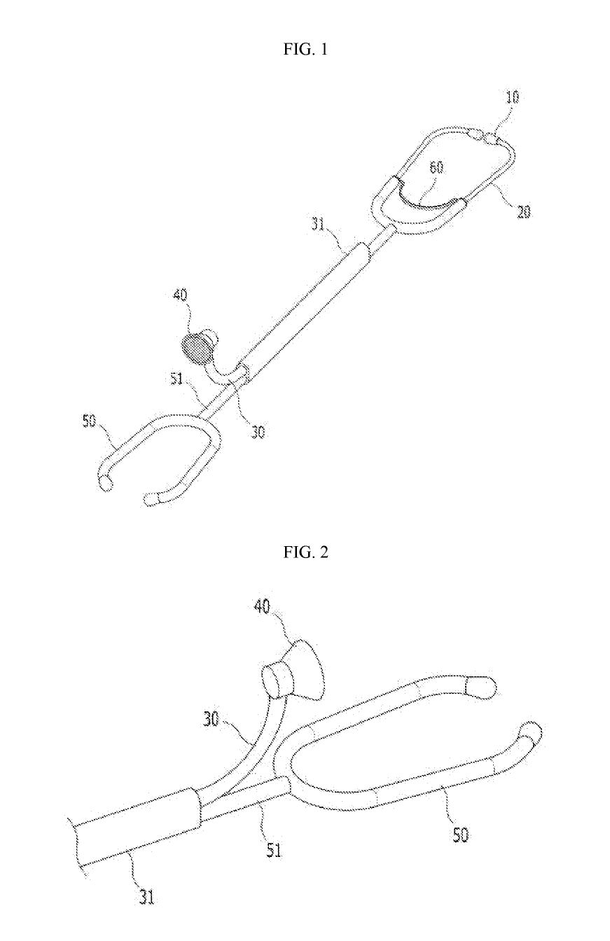

Hereinafter, according to exemplary embodiments of the inventive concept, a hearing aid will be described referring to FIGS. 1 through 3.

As shown in FIG. 1, a hearing aid includes a sound collecting plate 40 for collecting sounds to transmit the same to a receiver. The collecting sound may be applicable to any devices if they can collect sounds and transmit the same, and the present inventive concept describes two kinds of devices which are preferable.

The sound collecting plate may be formed like a chestpiece of a stethoscope. That is, a diaphragm and a bell may be included in the sound collecting plate like a chestpiece of a stethoscope.

Generally, a chestpiece of a stethoscope is required to listen to internal sounds of a patient's body that are the sounds from intestines and blood flow in arteries and veins including heart sound and breath sound to check whether the body is in a regular condition or not. Also, the stethoscope is used to listen to the sounds from artery in the arm when taking the patient's pulse.

The chestpiece generally includes a diaphragm on one side and a bell on the other side. The diaphragm is a membrane that vibrates according to the sound waves in the wavelength of 100 Hz through 1 KHz, that is, usually the sounds from lungs and intestines.

The bell is caved in like a bell shape through which the wavelength of 20 Hz through 200 Hz, usually the sounds from opening and shutting of heart valves or back flowing or swirling of blood flow, may be heard. The sounds are relatively low pitch. Requesting to stop breathing in treatment is for listening to the exact heart sound.

The way to listen to small-scale sounds is important in diagnosis through a stethoscope, because small-scale sounds come from heart, lungs, or intestines are gathered through sound collecting parts and transmitted to the listener. The bell is used to listen to the sounds of low frequencies, and the diaphragm is used to listen to the sounds of relatively high pitch and wider wavelength. The difference is caused by the structure of sound collecting parts. The sound generated in the body vibrates air without a membrane that vibrates in the bell, thus, small-scale sounds may be heard. By the way, in case of the diaphragm, once vibrations from the skin are transmitted to a plastic membrane that vibrates, and the vibrations of the plastic membrane vibrate air to transmit the sound. During that process, small-scale sounds are absorbed to the membrane that vibrates itself and may not be transmitted further, accordingly, the diaphragm requires vibrations over a certain level.

Listening to the internal sounds through a stethoscope is that the internal sounds vibrate the membrane of the stethoscope, and then the vibrations are transmitted to the doctor's ear. Sound is a wave transmitted through a medium, wherein the progress direction of the wave and the vibrating direction of the medium are same as a longitudinal wave.

Such the chestpiece is identical to the principle of the sound collecting plate, accordingly, effects according to exemplary embodiments of the present inventive concept may be obtained easily by using the chestpiece of a stethoscope. Also, just one of the diagram and the bell of the chestpiece may be used as a sound collecting plate, and both of the above may be used as a sound collecting plate as occasion demands.

The sound collecting plate may be formed as a microphone for transmitting sounds. The microphone may be a kind of transducer. This is a transducer for transferring sound energy to electric energy, which is necessary for modern sound systems. In a composition of a simple sound reinforcement system using a microphone, sounds collected in a microphone are input to a console to go through gaining and frequency equalization, and then, amplified by a power amplifier and come out through a loudspeaker.

A microphone is divided into a dynamic microphone and a condenser microphone largely. Such the microphone may be classified under some kinds according to converting principles, pickup patterns, and main functions. Also, electric features such as frequency response, output level, output impedence, selfnoise floor, distortion, polar response, or the like, are necessary to be identified for using the microphone well in a sound system.

The dynamic microphone is composed of light diaphragm connected to a thin aluminum coil and a permanent magnet. The diaphragm of the microphone vibrates back and forth according to sound pressure when sound wave is generated from a sound source. Then, the coil connected to the diaphragm moves together, and at this time, magnetic field is formed between the permanent magnetic and the coil, and accordingly, a voltage is generated along the coil. That is, the dynamic microphone is for converting the input sound pressure into an electric signal by using magnetic field between the coil and the magnetic.

The condenser microphone is for outputting an electric signal generated due to electric capacity caused by the movement of diaphragm according to the sound pressure and the charge amount maintained in a certain amount between a backplate and the diaphragm through an amplifier.

Recent condenser microphones applies material having polarity so-called electrets material. This material is located in the backplate of the microphone generally.

A voltage changes according to the relationship between electric capacity change generated by the diaphragm and the electrets material while the surface of the metal processed diaphragm moving according to the sound pressure and the certain amount of charge, which amplifies the electric signal by a pre-amplifier.

The hearing aid includes a first connecting tube 30 connected to the first sound collecting plate 40 for transmitting the sounds collected in the sound collecting plate and an earpiece 10 for a receiver connected to the first connecting tube for listening to the sounds collected in the sound collecting plate.

The earpiece for a receiver is inserted to fit the direction of the external auditory meatus to listen to the sound well while placing a little bit bent side at the front and sticking to the ear skin. The earpiece is a part for transmitting the sound lastly in the ear, so it is possible to wear the same for a long time when it fits the ear hole properly and the wearing feeling is not painful. And also, it is preferable to use material harmless to a human body because the earpiece contacts the human body.

The first connecting tube 30 is like a pathway for transmitting a sound source caught by the sound collecting plate to the ear. A certain product may miss a high frequency wavelength structurally, accordingly, a short connecting tube may be used for avoiding this.

The hearing aid includes a necklace unit 50 for a sender surrounding the sender's neck so as to transmit sender's voice through the sound collecting plate. The necklace unit for a sender helps for a sender to talk conveniently in transmitting his voice through the sound collecting plate without using his hands.

The hearing aid further includes a binaural 20 formed between the earpiece for a receiver 10 and the first connecting tube 30. The binaural is a part hung on the two ears and transmits the sound transmitted through the connecting tube to the earpiece.

The binaural 20 is usually made up of reinforcement aluminum, steel, or copper, and sometimes plastic as occasion demands.

Each of the earpiece for a receiver and the binaural may be formed on both sides dividing in the first connecting tube in the form of Y, and at this time, a connecting bridge 60 is further included to connect the divided first connecting tube.

A supporter 51 to support the necklace unit for a sender on the sender's neck is further included. The supporter 51 supports for the necklace unit for a sender to be disposed lean on the sender's neck.

At this time, a second connecting tube 31 wrapping the first connecting tube and the supporter is further included as shown in FIG. 2. The second connecting tube enables to secure utility by wrapping the supporter and the first connecting tube so as not to be detached with each other.

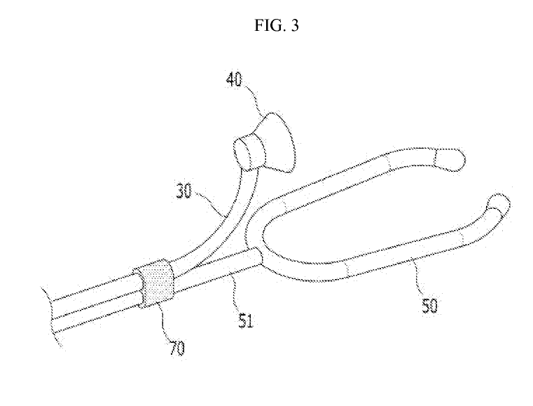

A joining member 70 to join the first connecting tube and the supporter and fix the same is further included as shown in FIG. 3. Such the joining member has an effect of joining the first connecting tube and the supporter and fixing the same simply without adding a separate structure like the second connecting tube of FIG. 2.

While the present invention has been particularly shown and described with reference to exemplary embodiments thereof, it will be understood that various changes in form and details may be made therein without departing from the spirit and scope of the following claims.

### INDUSTRIAL USABILITY

The present invention is applicable to a hearing aid.

What is claimed is :

1. A hearing aid comprising:
a sound collecting plate collecting sounds to transmit sender's voice to a receiver;
a first connecting tube connected to the sound collecting plate to transmit the sound collected in the sound collecting plate;
an earpiece for a receiver connected to the first connecting tube for listening to the sound collected to the sound collecting plate; and
a necklace unit surrounding the sender's neck for the sender to transmit his voice through the sound collecting plate.

2. The hearing aid of claim 1 further includes a binaural formed between the earpiece for a receiver and the first connecting tube.

3. The hearing aid of claim 2, wherein the binaural is formed on both sides of the first connecting tube divided in bidirectional ways respectively.

4. The hearing aid of claim 3 further includes a connecting bridge connecting the first connecting tube divided in bidirectional ways.

5. The hearing aid of claim 1 further includes a supporter connected to the necklace unit for a sender to support the necklace unit lean on the sender's neck.

6. The hearing aid of claim 5 further includes a second connecting tube wrapping the first connecting tube and the supporter.

7. The hearing aid of claim 5 further includes a joining member for joining the first connecting tube and the supporter and fixing the same.
